(19) United States
(12) Patent Application Publication
(10) Pub. No.: US 2008/0233547 A1
(43) Pub. Date: Sep. 25, 2008

(54) Reading motivational system

(76) Inventor: Marilu Patterson, Buffalo Grove, IL (US)

Correspondence Address: McKenna McGovern Burkhart, 134 North LaSalle Street, Suite 2040, CHICAGO, IL, 60602, US

(21) Appl. No.: 11/726,914

(22) Filed: Mar. 22, 2007

(51) Int. Cl. G09B 17/00

(52) U.S. Cl. 434/178

(57) ABSTRACT

A method of promoting literacy through encouraging reading includes the step of providing a medium capable of storing and displaying information. Information relating to an individual is entered onto the medium, with at least a portion of the information being related to current reading materials of the individual. The medium is placed into a display mechanism adapted and constructed to be worn on the person of the individual, and the display mechanism is then worn by the individual.

### FIELD OF THE INVENTION

This application is directed generally to motivational systems for encouraging reading and in particular to encouraging reading by adolescents.

### BACKGROUND

The National Literacy Act of 1991 which defined literacy as “an individual's ability to read, write, and speak English and compute and solve problems at levels of proficiency necessary to function on the job and in society, to achieve one's goals, and to develop one's knowledge and potential”. With society's increasing reliance upon written and spoken information in virtually every aspect of life, the importance of literacy can hardly be overemphasized.

Similarly, the link between literacy levels and the amount of reading performed by a child is well-established. According to the international Reading Association, it is during the middle years of schooling that most students refine their reading preferences, become sophisticated readers of informational text, and lay the groundwork for the lifelong reading habit. They begin to use reading to help answer profound questions about themselves and the world. With good instruction, ample time, and opportunity to read a variety of texts, young adolescents can become successful readers both in and out of school.

Not surprisingly, the use of motivational tools in encouraging reading has been the subject of a high degree of inventive activity. For example, U.S. Pat. No. 6,629,845 to Zwiers is directed to a method of motivating a child to want to do what is beneficial, including the steps of (a) providing an item which the child interacts with to establish a play pattern that is fun for the child, (b) packaging the item in a manner that is convenient to use and wherein the packaging assists in establishing the play pattern

In another example, U.S. Pat. No. 6,598,878 to Burrowes deals with a game for teaching vocabulary playable as a competition between two or more players having comparable or disproportionate vocabulary skills. The game includes a game board with a play surface including a start point space, an end point space and a plurality of movement spaces arranged linearly to form a sequentially predetermined play path, select ones of the plurality of movement spaces including a first indicia for indicating a play command to a player, a set of game cards, each of the game cards including at least one vocabulary clue and a corresponding answer, a select one of the vocabulary clue of a select game card corresponding to a difficulty level which matches a vocabulary skill level assigned to a player, a set of PASS cards, each of the PASS cards being distributable to at least one opposing player when a player passes a turn, and redeemable by a passing player possessing a PASS card, a plurality of play pieces configured for marking movement on the play path between the start point space and the end point space, each of the plurality of play pieces being assignable to a player, and means for randomly generating a number to determine the number of movement spaces to move a current player's play piece along the play path. The invention is further directed to a computerized version of the game.

In an unrelated technology, various jewelry configurations have been adapted to contain information, or hold ornamental objects. For example, U.S. Pat. No. 7,127,782 to Skiles shows a clasp apparatus to releaseably hold an ornamental object. That ornamental object may have a spherical shape or an irregular shape. A method to releaseably hold an ornamental object is also described.

U.S. Pat. No. 6,419,158 to Hooglander concerns a system and method for carrying personal and/or medical information, including a locket designed to contain a memory electronic device to store information about the user. The locket is design to be opened to provide ready access to a machine readable portion of the memory device by a reader. The locket is combined with a pocket in a shoe to carry the locket unobtrusively. The locket and pocket can include a logo which will alert medical or other emergency personnel as to the existence of the locket during an emergency.

U.S. Pat. No. 6,123,240 to Fowles, et al. is directed to a carrying case for a pager including a pouch having first and second compartments. The first compartment is sized to receive the pager therein and the second compartment is provided for receiving other items such as a credit card, driver's license, money, etc. which the user may need. A shield is positioned between the first and second compartments for shielding any items within the second compartment from being damaged by and electromagnetic waves produced by the beeper. This shield will aid in preventing such electromagnetic waves from erasing or damaging the magnetic strip on a credit card or bank card. A cover is provided for selectively covering the first and second compartments to thereby secure the beeper within said first compartment and whereby the beeper is fully operational when positioned within the first compartment and covered by the cover. A chain may be connected to the pouch for retaining the pouch around a body part of a user.

U.S. Pat. No. 5,731,629 to Woodward shows a personal data storage device for storing information and a system for storing and reading such information from the storage device. A programmable memory is encapsulated in a potting compound which includes a plurality of channels enclosing leads of the memory package. The channels extend to the outside of the encapsulated memory to permit exterior contact with the memory leads. A conductive sealant placed in the channels for sealing the channels of the encapsulated flash memory makes electrical contact with the leads. A device for reading the information from the data storage device includes a PCMCIA interface which can read and write data to and from the personal data storage device and a computer. The computer further includes programming for compressing and decompressing data which is stored and read from the personal data storage device.

Educators have formulated a variety of tools to motivate students to embrace their studies. Among the oldest of these tools is the use of “stories”. The power of story as a teaching tool is increasingly being recognized. In “Story Factor”, Annette Simmons theorizes that the oldest tool of influence is also the most powerful. The words, gestures, tone, and rhythm of story can be used to captivate an audience of skeptical, resistant, nay-sayers and simultaneously construct a believable picture for ideas and goals to be communicated.

While each aspect described above is generally beneficial, the existing art fails to contemplate any combination of the power of story with ornamental accessories put together in such a way as to promote literacy through increased reading.

### SUMMARY

A method of promoting literacy through encouraging reading includes the step of providing a medium capable of storing and displaying information. Information relating to an individual is entered onto the medium, with at least a portion of the information being related to current reading materials of the individual. The medium is placed into a display mechanism adapted and constructed to be worn on the person of the individual, and the display mechanism is then worn by the individual.

### DESCRIPTION OF THE DRAWINGS

FIG. 1 illustrates a system for encouraging reading.

FIG. 2 illustrates an alternative embodiment of a system for encouraging reading.

### DETAILED DESCRIPTION

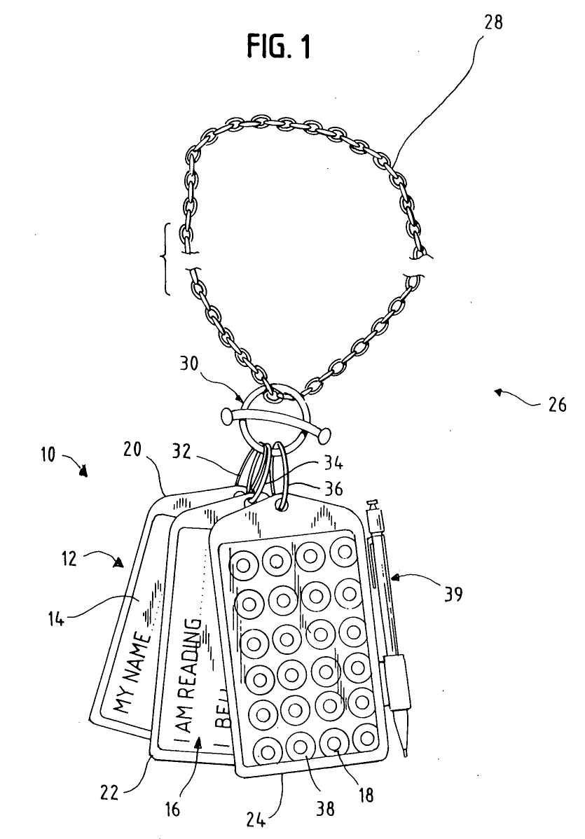

FIG. 1 illustrates a system 10 for encouraging literacy through reading in accordance with the principles of the present invention. The system 10 includes a medium 12 capable of storing and displaying information. In the illustrated embodiment, the medium 12 is shown as a plurality of cards 14, 16, 18 in plastic sleeves 20, 22, 24. The sleeves 20, 22, 24 are adapted and constructed to be worn on the person of the individual by attachment to a necklace assembly 26. In the illustrated embodiment, the necklace assembly 26 includes a chain 28, a symbolic ornamental element 30, and a plurality of clasps 32, 34, 36.

The cards 14, 16, 18 are designed to contain information relating to an individual wearing the necklace 26. They can also include decorative indicia 38. Particularly, the cards 14, 16, 18 contain information regarding current reading materials of the individual and other personal information. A data entry mechanism, here shown as a pen 39, can be included and attached to the display mechanism.

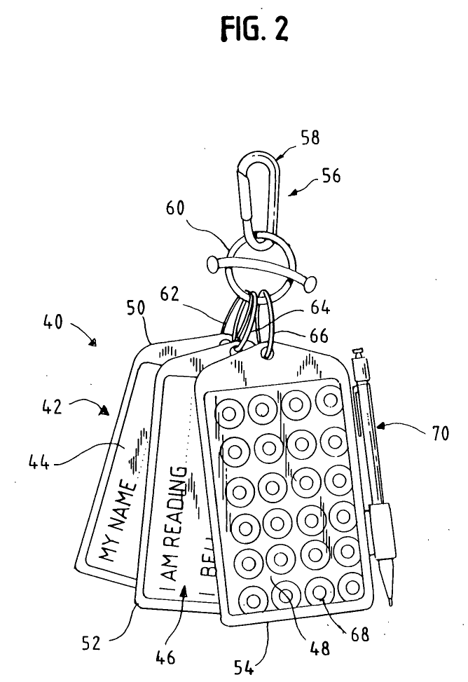

An alternative embodiment of a system 40 for encouraging literacy through reading in accordance with the principles of the present invention is illustrated in FIG. 2. The system 40 includes a medium 42 capable of storing and displaying information. In the illustrated embodiment, the medium 42 is shown as a plurality of cards 44, 46, 48 in plastic sleeves 50, 52, 54. The sleeves 50, 52, 54 are adapted and constructed to be worn on the person of the individual by attachment to backpack attachment assembly 56. In the illustrated embodiment, the backpack attachment assembly 56 includes a carabiner 58, a symbolic ornamental element 60, and a plurality of clasps 62, 64, 66.

The cards 44, 46, 48 are designed to contain information relating to an individual wearing the backpack to which the system is attached. They can also include decorative indicia 68. Particularly, the cards 44, 46, 48 contain information regarding current reading materials of the individual and other personal information. A data entry mechanism, here shown as a pen 69, can be included and attached to the display mechanism.

In the illustrated embodiments, the symbolic ornamental elements 30, 60 include a circle or “O”-shaped portion representing the circle of life. The bar across the circle represents people crossing over to one another to connect. The information on the cards is designed to encourage such connections as they relate to reading. It is contemplated that individuals wearing the systems will read the information on one another's cards. This will act as an “icebreaker” in making personal connections among readers, along with accomplishing a variety of other desirable goals, including exposing the reader to a wider array of reading materials, give details regarding these materials, and promote competition as to the type and volume of reading being performed.

A plurality of cards including a poem or other literary device containing information on the systems 10, 40 can be included in each system. The literary device can be distributed to encourage others to gather further information on the system, and to join in.

The system 10, 40 is particularly well-suited to use in a school environment, as they promote healthy reading and sharing in the classroom and surrounding environs while providing a productive outlet for fun and competition. The systems can be used in the context of contests, for example, in which individuals or groups are awarded points for the number of books read.

By wearing the systems around the necks of individuals or attached to backpacks, the systems are readily available for others to grab and share. They also create a sense of curiosity in others regarding the contents of the cards.

Although examples of implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

I claim as my invention:

1. A method of promoting literacy through encouraging reading, the method comprising the following steps:
(a) providing a medium capable of storing and displaying information;
(b) entering information relating to an individual onto the medium, with at least a portion of the information being related to current reading materials of the individual;
(c) placing the medium into a display mechanism adapted and constructed to be worn on the person of the individual; and
(d) causing the display mechanism to be worn by the individual.

2. The method in accordance with claim 1, wherein the step of providing a medium capable of storing and displaying information comprises providing at least one card capable of being written upon.

3. The method in accordance with claim 1, wherein the step of providing a medium capable of storing and displaying information comprises providing a plurality of cards capable of being written upon.

4. The method in accordance with claim 2, wherein the step of entering information relating to an individual comprises writing the information onto at least one card.

5. The method in accordance with claim 1, wherein the step of placing the medium into a display mechanism comprises placing the medium onto an article of jewelry.

6. The method in accordance with claim 5, wherein the step of placing the medium onto an article of jewelry comprises placing the medium into a pendant portion of a necklace.

7. The method in accordance with claim 2, wherein the step of placing the medium into a display mechanism comprises placing the medium onto a backpack attachment.

8. The method in accordance with claim 2, wherein the step of placing the medium into a display mechanism comprises inserting the at least one card into a transparent sleeve.

9. The method in accordance with claim 1, further comprising the step of providing a data entry mechanism adapted and constructed to enter information onto the medium.

10. The method in accordance with claim 9, wherein the step of providing a data entry mechanism comprises providing a pen.

11. The method in accordance with claim 10, further comprising providing a symbolic ornamental element on the display mechanism.
